(19) United States
(12) Patent Application Publication
(10) Pub. No.: US 2008/0076679 A1
(43) Pub. Date: Mar. 27, 2008

(54) Systems and methods of combinatorial synthesis using laser-assisted thermal activation

(75) Inventors: Wei Shan, Fremont, CA (US); Qizhen Xue, Pleasanton, CA (US); Xiao-Dong Xiang, Danville, CA (US)

Correspondence Address: BUCHANAN, INGERSOLL & ROONEY PC, POST OFFICE BOX 1404, ALEXANDRIA, VA, 22313-1404, US

(73) Assignee: Intematix Corporation, Fremont, CA (US)

(21) Appl. No.: 11/893,598

(22) Filed: Aug. 16, 2007

Related U.S. Application Data
(60) Provisional application No. 60/838,510, filed on Aug. 16, 2006.

(51) Int. Cl. C40B 50/18; C40B 60/14

(52) U.S. Cl. 506/32; 506/40

(57) ABSTRACT

Disclosed herein are systems and methods of a combinatorial synthesis technique that produces functional materials from a plurality of chemical elements with a compositional gradient either continuously varying across the sample, or where the mole fractions are discretely varied. A contactless heating mechanism, such as a pulsed laser, provides in situ thermal activation necessary for promoting and controlling reaction between precursors, inter-diffusion of precursor atoms, and thermal annealing that is essential for crystallization of deposited materials. The heating may be spot selective and temperature variable so that the required thermal annealing may be conducted in a combinatorial manner.

### CROSS REFERENCE TO RELATED APPLICATION

This application claims the benefit of priority to U.S. Provisional Application No. 60/838,510, filed Aug. 16, 2006, the specification and drawings of which are incorporated herein by reference.

### BACKGROUND OF THE INVENTION

1. Field of the Invention

Embodiments of the present invention are directed in general to the synthesis of combinatorial libraries. More specifically, the field of the present invention is direct to the use of laser-assisted thermal activation of precursors, reactants, and compounds in combinatorial libraries.

2. Description of the Related Art

Combinatorial synthesis is a time-efficient and cost-effective technique for developing new functional materials. By depositing a certain number of chemical elements in various combinations of atomic mole fractions of the respective elements, discretely or continuously, and on single or multiple substrates, one may investigate the complex relationships between the composition, crystalline structure, and physical properties of such a multi-component material system. New functional materials may be discovered combinatorially such that the composition of the constituents that produces the best performance of the library may be identified quickly and efficiently. Combinatorial materials may be synthesized to contain diverse, discrete compositions in the library to examine a specific segment in a large scale of compositional combinations. They can also be produced to have a continuous variation in composition, much like the physical representation of a ternary phase diagram (assuming three components) to map out phase boundaries so that important regions of interest may be identified.

To date, the vast majority of combinatorial synthesis using physical vapor deposition is carried out in essentially two steps: (1) depositing multilayer film on a substrate from two or more precursor sources that are spatially separated and chemically distinct, resulting in a stacked thin film with a composition gradient (by employing continuous moving shutters, or a group of discrete chips each with predetermined concentrations of respective precursors by deploying discrete shadow masks); and (2) carrying out a post-deposition thermal annealing step to activate simultaneous reaction and inter-diffusion of deposited constituents in a furnace to generate the designed alloys and compounds of the library. Sometimes a substrate may be preheated to an elevated temperature in the hope of providing the initial thermal activation necessary for reaction and inter-diffusion during deposition.

Thermally activated simultaneous reaction and inter-diffusion are inevitable in the combinatorial synthetic process that employs a physical vapor deposition, because a combinatorial multilayer stack of precursors will generally not inter-diffuse, and crystallize, unless thermally annealed. The thermal environment that promotes and controls the reaction, and the inter-diffusion, plays a key role in determining the final products characteristics in terms of stoichiometry, phase structures, and chemical, electrical, optical, and magnetic properties. Therefore, it is desirable to have methods of combinatorial synthesis that are not only capable of depositing materials in combinatorial way, but also able to conduct thermally activated inter-diffusion and annealing during or after combinatorial deposition. It is desirable to provide thermal activation either in situ or ex situ. Addition, more time-efficient and cost-effective methods are provided if the thermal activation and annealing may be carried out in a combinatorial way, similar in principle anyway to the combinatorial to the manner in which the deposition had been performed.

### SUMMARY OF THE INVENTION

Embodiments of the present invention are directed to systems and methods for producing combinatorial libraries of materials, wherein the product libraries are thermally activated in situ to promote reaction and interdiffusion with precursor materials. In some embodiments, the thermal activation is provided by a laser beam, which may be operated in either continuous or pulsed mode.

A typical system comprises a vacuum chamber, a substrate contained within the vacuum chamber, a source target of precursor materials, an ion beam for sputtering precursor material from the source target such that the precursor materials are deposited on the substrate, a masking shutter system for controlling the amounts of each of the precursor materials that are deposited on the substrate, and a laser beam for thermally activating the precursor materials that have been deposited on the substrate, and to cause the formation of a product from the precursor materials. The compositional gradient of the product varies in either a continuous or discrete manner, and may be referred to as a “phase diagram.”

The system may further include a quasi-monochromatic light source (“quasi-monochromatic” defined as a range of wavelength less than 1000 nm in one embodiment, less than 100 nm in another embodiment, less than 10 nm in another embodiment and less than 1 nm in another embodiment) for illuminating an area of a surface of the product; a modulated laser beam focused onto a region smaller than and within the area illuminated by the quasi-monochromatic light, and configured to generate a differential reflectance signal, a photodetector for receiving reflected light from the product, and a phase-sensitive lock-in detection system for differentiating and amplifying the differential reflectance signal detected by the photodetector. The ratio of the area of the modulated laser beam to the quasi-monochromatic light source may range from 1:1 to 1:10; 1:10 to 1:100; 1:100 to 1:1,000; and 1:1,000 to 1:10,000 in various embodiments. The system may further include a steering mirror for moving the modulated laser beam to different regions of the product receiving the quasi-monochromatic light.

Embodiments of the present invention further include methods of producing a combinatorial library of materials, the method comprising sputtering precursor materials from source target such that the precursor materials are deposited on a substrate, and thermally activating the precursor materials on the substrate to cause reaction between the precursor materials and form a product. The method may further include illuminating a surface of the product with quasi-monochromatic light, focusing a modulated laser beam onto a region within, and smaller than, the region of the product illuminated by the quasi-monochromatic light, and detecting a differential reflectance signal from the region of the product receiving the modulated laser light.

### BRIEF DESCRIPTION OF THE DRAWINGS

FIG. 1 is a schematic diagram of a physical vapor deposition system for the combinatorial synthesis of libraries of functional materials;

FIG. 2 shows the operational principles of one embodiment of a combinatorial ion-beam sputtering system;

FIG. 3 illustrates two selective laser heating schemes for thermal activation, interdiffusion, and annealing on an exemplary 4×4 matrix;

FIG. 4 is a schematic illustration of an in situ reflection measurement for monitoring the effects of laser heating and consequent thermal annealing of the materials being prepared in an exemplary combinatorial synthesis system;

FIG. 5 is a graph of the reflection results measured from a spot on a GeSbTe phase diagram as a function of the duration of the laser heating (annealing time);

FIG. 6 is a schematic of a high-throughput optical mapping and screening configuration using photoreflectance; and

FIG. 7 is a diagram showing how the optical response from a sample in a combinatorial materials library, in the form of an exemplary ternary phase diagram, may be mapped out using photoreflectance measurements.

### DETAILED DESCRIPTION OF THE INVENTION

Disclosed herein are methods of combinatorially synthesizing functional materials composed from a number of different precursors that are chemically distinct with a great variety of combinations of atomic compositions are provided. The methods include physical vapor deposition of a number of precursors with similar or dissimilar chemical and/or physical properties on selected substrates, followed by laser-assisted thermal activation of interdiffusion between different layers of precursor atoms as well as crystallization of the deposited materials via rapid epitaxial growth. The methods make it possible to yield designed functional materials during the combinatorial synthesis process without the necessity of post-deposition furnace heating to activate simultaneous reaction and inter-diffusion of precursor multilayers and thermally anneal the as-deposited amorphous multilayer stack of precursors into crystallized combinatorial materials.

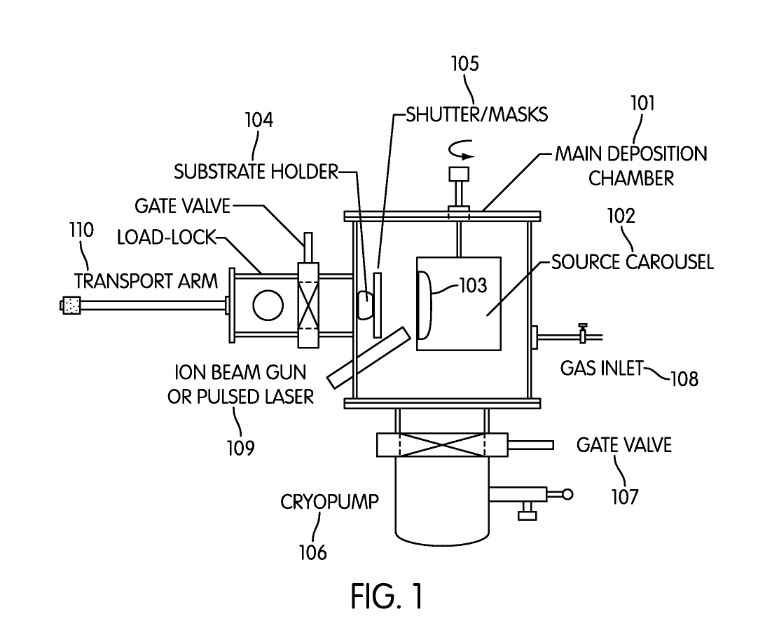

Disclosed herein are systems methods of synthesizing combinatorial libraries in the configuration of a phase diagrams and/or a material chip. Physical vapor deposition (PVD) methods including thermal evaporation, electron-beam evaporation, sputtering, and pulsed laser deposition with a plurality of precursor sources may be used for this purpose. A physical vapor deposition system based on ion-beam sputtering and pulsed laser deposition is schematically illustrated in FIG. 1. The main deposition chamber 101 of this physical vapor deposition system houses a shrouded source carousel 102 on which a plurality of source targets or a set of effusion cells 103 may be installed, and in which a plurality of source materials can be loaded. A substrate holder 104 with a movable shutter/mask combination 105 may be positioned in front of the source targets 103. A flux of precursor atoms may be generated using ion-beam gun sputtering or a pulsed laser bombarding the source targets. There may be located one or more transparent side windows on the chamber to provide optical access to the substrate area for visual inspection, laser heating and/or thermal annealing, as well as optical measurements during and after the combinatorial deposition.

The exemplary deposition chamber of FIG. 1 may be further provided with a means for exhausting gases from the deposition chamber, such as the cryopump 106 (but ion pumps and the like may be provided as well), and a valve system for regulating the pressure in the deposition chamber, such as gate valve 107. Gas inlet 108 provides the precursor materials to the deposition chamber 101. Ion beam gun or pulsed laser 109 causes the sputtering or sublimation of atoms from source target 103. Samples may be inserted into the deposition chamber 101 by means of transport arm 110. Load lock 111 and gate valve 112 may be used to facilitate substrate loading and unloading.

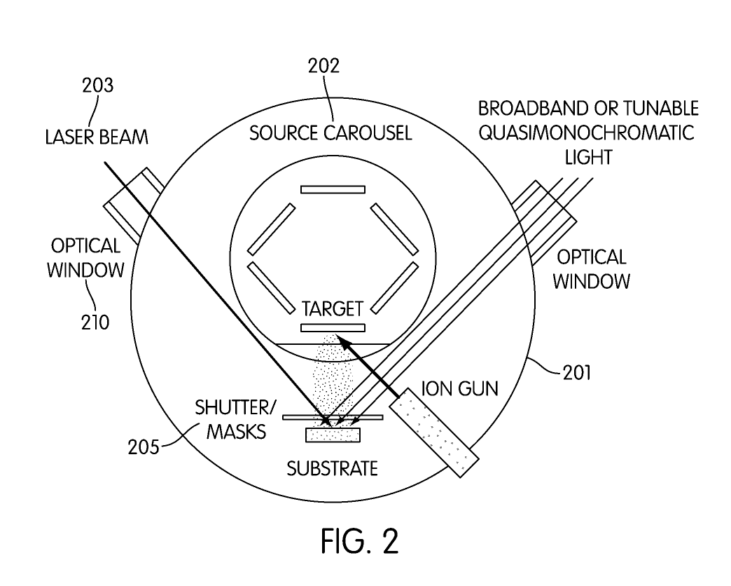

In one embodiment, post-deposition thermal activation and annealing of the deposited, combinatorial materials may be carried out in situ, whereas traditionally this processing step needed to be performed ex situ. Of course, it will be understood that annealing does not have to be done in situ; and in an alternative embodiment, only a portion of the total annealing required is done in situ. As example of the operating principle of an ion-beam sputtering system designed for combinatorial synthesis is shown in FIG. 2. The system is designed to produce a multi-precursor, gradient-composition sample referred to as a phase diagram, via a by physical vapor deposition followed by a post-deposition annealing (thermal activation) of the multilayer structure, in a single run. For example, a ternary phase diagram may be produced by gradient deposition of three precursors using linear shutters 205 that move at a controlled rate during each precursor deposition. In this way, precise control of molar stoichiometries within a given small area can be made because the compositional variation is directly correlated to the dimensions of the sample in a linear scale during deposition. See, for example Y. K. Yoo and X. D. Xiang, in Combinatorial Materials Synthesis, X. D. Xiang and I. Takeuchi, eds. (Marcel Dekker, New York, 2003), chapter 8. This system may also be used to make spatially separated discrete depositions on a single substrate. The product library produced in this manner may be referred to as a “material chip.” Such libraries may be fabricated using shadow masks with each chip having its own distinct composition of precursors. See, for example, U.S. Pat. No. 5,985,356.

In some embodiments, the main chamber 201 needs to be maintained at an ultra-high vacuum of better than 10⁻¹⁰ Torr, often throughout the synthesis, to prevent the deposited precursor layers from being oxidized. Oxygen contamination is detrimental to metallic alloys and non-oxide compounds such as semiconductors. Even with oxide synthesis this ultra-high vacuum condition is highly desirable, as oxygenation may be carried out under a controlled, oxygen over-pressure during the post-deposition annealing reaction and while inter-diffusion is occurring precursor layers.

In a preferred embodiment, all or a portion of a laser beam 203 may be directed through an optical window 210 to illuminate the substrate area, while further providing a heating mechanism necessary for the inter-diffusion process to occur. The laser beam may also cause reaction between as-deposited amorphous layers of precursor materials on the substrate. The laser heating may be carried out during the deposition of the precursor materials, and/or after the deposition of a stack of multilayers is completed, to activate interaction and promote inter-diffusion between amorphous precursor layers.

The effectiveness and the efficiency of laser heating, and its subsequent thermal annealing of the sample, depend on the operational modes of the laser to be used, as well as the type of laser and the functional parameters associated with the laser's use. A critical classification of laser types is whether they are pulsed, or continuous-wave (CW). Such lasers consists of, but are not limited to, excimer lasers, gaseous lasers, solid state lasers, semiconductor laser diodes, dye lasers, oscillators, and harmonic generators pumped by any aforementioned lasers. Functional parameters include (but are not limited to) the wavelength of the electromagnetic radiation emitted by the laser, the power density delivered to the sample, the exposure time of the laser illumination, the pulse width and repetition rate, and energy fluence (in the case of a laser operating in pulsed mode).

In one embodiment a pulsed laser is used. The heating effect of an appropriately chosen pulsed laser may induce melting of a stack of as-deposited amorphous precursor multilayers, followed by rapid epitaxial growth, yielding crystallized materials as members of a combinatorial library. Pulsed laser heating-induced melting involves the absorption of laser radiation, the melting of the amorphous layers, and subsequent rapid epitaxial growth. The epitaxial growth may be seeded at the solid-liquid interface by a crystalline material in the bulk, such as a crystalline substrate, in a manner similar to liquid phase epitaxy, but with the entire process occurring on a shorter time scale (typically between 10⁻⁸-10⁻⁶ second). See, for example, Laser and Electron Beam Processing of Materials, C. W. White and P. S. Peercy, eds., (Academic Press, New York, 1980); and J. S. Williams in Laser Annealing of Semiconductors, J. M. Poate and J. W. Mayer, eds., (Academic Press, New York, 1982), p. 385. These references describe a pulsed laser melting method for annealing amorphous layers of semiconductor materials such as GaAs, the semiconductor layers formed by high dose implantation. The experiment demonstrated that product thin films may be re-grown into nearly perfect single crystals, with the electrical activities of the dopants well above those levels achievable by furnace annealing. Due to the rapid crystallization rate, this approach is very effective at generating well mixed alloys from stacked multilayers, to a degree that mixing may be well above the solubility limit.

Another advantage of using laser heating to provide thermal activation and annealing is that the spot size of a laser beam may be manipulated, while its power density is maintained at the same level, with the use of the same using appropriate optics. This affords the thermal activation/annealing to be targeted selectively either to a specific region of a gradient library phase diagram, or to an individual address, or group of addresses, on a combinatorially synthesized material-chip library.

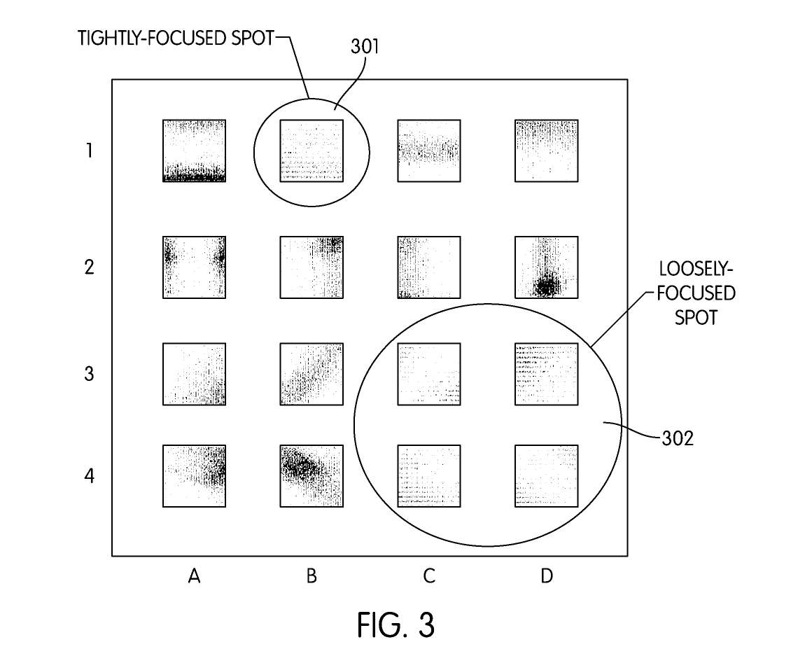

This concept is illustrated in FIG. 3, where a 4×4 combinatorial materials matrix (one or more “materials chips”) is hypothetically deposited on a substrate prior to laser heating. The laser beam size may be varied to provide a heating spot size just large enough to cover a single element (chip) of the matrix (as shown by reference numeral 301), such that heating and thermal annealing are administered only to that particularly selected chip or array member. Such a selective heating step may be given to each of the elements of the array by steering the laser beam onto the individual elements, one by one, across the matrix. The same principle applies to a selected region that may include some elements, but not all of the elements of the matrix (as shown by reference numeral 302). According to embodiments of the present invention, the energy fluence of the laser pulses, a parameter related to the exposure time of the pulses and the number of pulses, may be varied for each of the individual heating events.

Embodiments of the present invention offer additional advantages to the art of combinatorial synthesis by allowing different processing conditions to be available to different elements of the library on a single substrate. Examples of the processing conditions that may be varied in situ, during a single deposition, are: (i) thermal annealing of an array of identical matrix elements deposited on a single substrate, with different elements of the matrix being illuminated under different laser heating conditions (energy fluence, power density, exposure duration, etc.); and (ii) thermal annealing under the same laser heating conditions for an array of combinatorial materials chips of different compositions of precursors deposited on a substrate with all the elements of the entire matrix being illuminated uniformly; (iii) a combination of both, i.e. thermal annealing of an array of combinatorial materials chips deposited on one single substrate with different elements of the matrix under different laser heating conditions. In this way post-deposition thermally activated inter-diffusion and reaction of precursor materials in an array of as-deposited stacked precursor multilayers, different from one another other but deposited on the same substrate, along with subsequent thermal annealing, may be carried out under different laser heating conditions. One of the important aspects of this method is that it is effectively equivalent to several different runs of combinatorial synthesis if the selective regional laser heating is conducted using different sets of parameters.

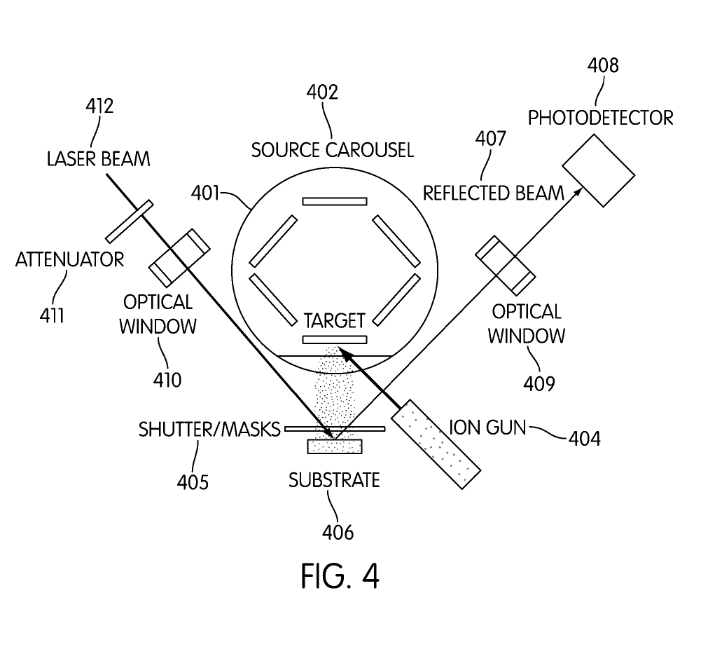

A further advantage of this embodiment is that the laser-assisted thermal annealing induces a structural change from an amorphous state of the material to a crystalline phase, and the change may be monitored in real time as to yield of crystallized material, and its quality. It is known that the reflectivity of a material system in an amorphous state differs from that in its crystalline state. In general, the reflectivity of the crystalline state is higher than that of the amorphous state. Therefore, a change in reflectivity of the sample subjected to laser heating may indicate a structural phase transition, and this in turn may be the result of heating from the laser-assisted thermal annealing. FIG. 4 schematically illustrates how this may be implemented.

Referring to FIG. 4, the laser power needed for the reflectivity measurement is much lower than that required for thermal activation and laser annealing, so an optical attenuator (which may be computerized) may be used to reduce the intensity of the laser beam relative to its intensity for thermal annealing. The measurement may be performed any time during the laser heating and subsequent thermal annealing, and it may be synchronized with the laser pulse sequences, depending on the combinatorial materials system and the synthesis conditions. In FIG. 4 is shown a source carousel 402 within a deposition chamber 401, equipped with a laser beam 412 for monitoring reflection measurements from a deposition created by an ion gun causing precursor atoms to be removed from a target and deposited on substrate 406. The target 403 is one of a multiplicity of targets on the source carousel 401. The intensity of the reflected beam 407 is measured by photodetector 408, after having passed through an optical window 409. Of course, the incident laser beam passes through an optical window of the chamber 402, in this case labeled as optical window 410. The laser beam 403 may pass through an attenuator 411.

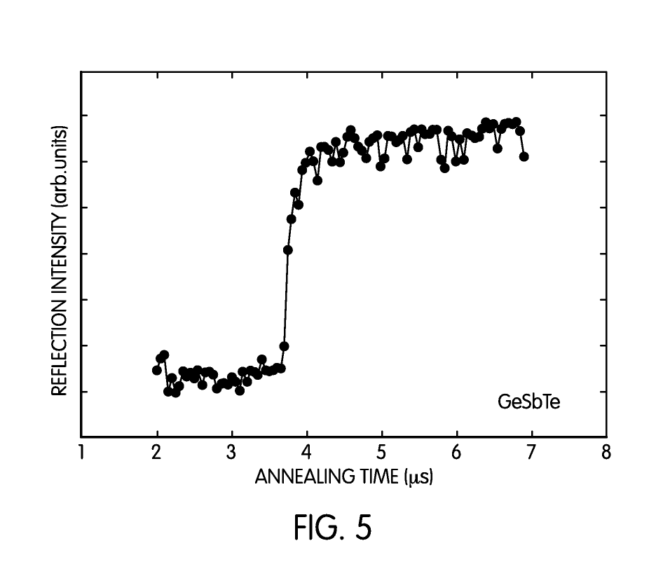

Data is provided in FIG. 5, which shows changes in the reflectivity from an illuminated spot of a ternary GeSbTe phase diagram. Here, the infinitely varying compositional gradient members of the combinatorial library have been subjected to a laser heating processing step. The variation in measured reflectivity illustrates how the structural properties of the material system vary as the laser heating duration time (e.g., annealing time) is correspondingly changed. In this figure it is shown that the sudden increase in reflectivity at an annealing time of about 4 microseconds indicates a structural transition from an amorphous to a crystalline phase. The power density in this experiment was 5×10⁴ W/cm².

Another embodiment of this invention is that high-throughput optical mapping and screening may be made in situ. Optical reflection, photoluminescence, and Raman scattering have been routinely employed to assess the properties (in most cases) of uniformly distributed homogeneous materials with very small compositional fluctuations. However, by the nature of a combinatorial experiment, the sensitivity and effectiveness of routine optical methods in the assessment of the combinatorial product may be in question. High throughput energy-gap mapping using reflection measurement would be time-consuming and potentially inaccurate. Photoluminescence and Raman scattering would be difficult to implement, due to the continuous variation in composition as well as the relatively poor crystalline quality (in polycrystalline form).

According to the present embodiments, the above mentioned drawbacks may be overcome by using photoreflectance measurements, particularly including a phase-sensitive modulation method with enhanced detection sensitivity. Photoreflectance is a modulation spectroscopic technique that uses a differential detection method by photo-injecting electrons to the conduction band of a given material. The material may be semiconducting or insulating by nature. The modulation is achieved via a periodically modulated light beam, and detection carried out by probing the differential changes that appear in the reflected signal. Changes in the reflected signal appear as sharp, derivative-like line shapes from a slow varying reflection spectrum, accompanied by broad and hard-to-resolve spectral features.

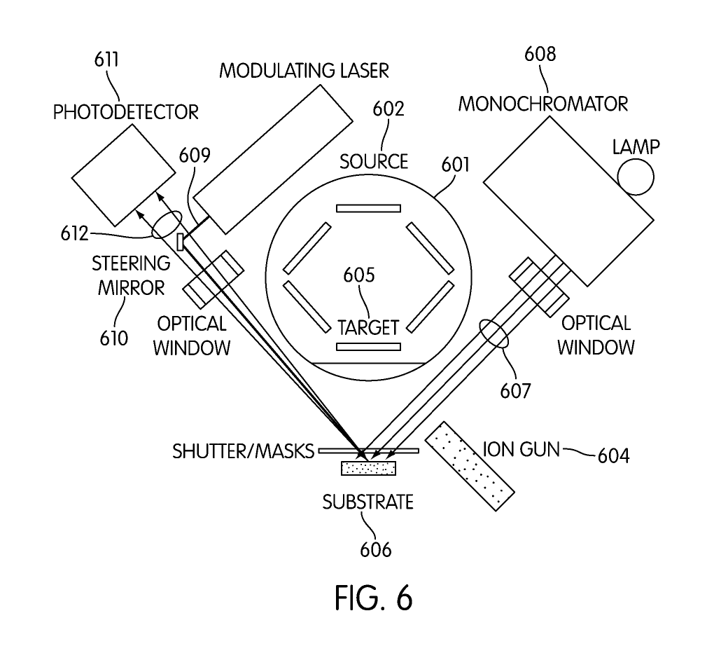

The optics of such a measurement system are illustrated in FIG. 6. As before, the deposition system comprises a source carousel 601 within a deposition chamber 602, an ion gun 604 for sputtering precursor atoms off target 605, which land on substrate 606. In the photoreflectance technique, a quasi-monochromatic beam 607 dispersed by a monochromator 608 illuminates on a sample and acts as a probe beam, where a laser beam 609 modulated by an optical chopper (not shown) is directed onto the same to provide the modulation. A steering mirror 610 (which may be computer controlled) may be used to steer the modulating laser beam across the entire sample. A photodetector 611 is connected to a phase-sensitive lock-in amplifier (not shown) detects the spectral response of modulated signals from the sample.

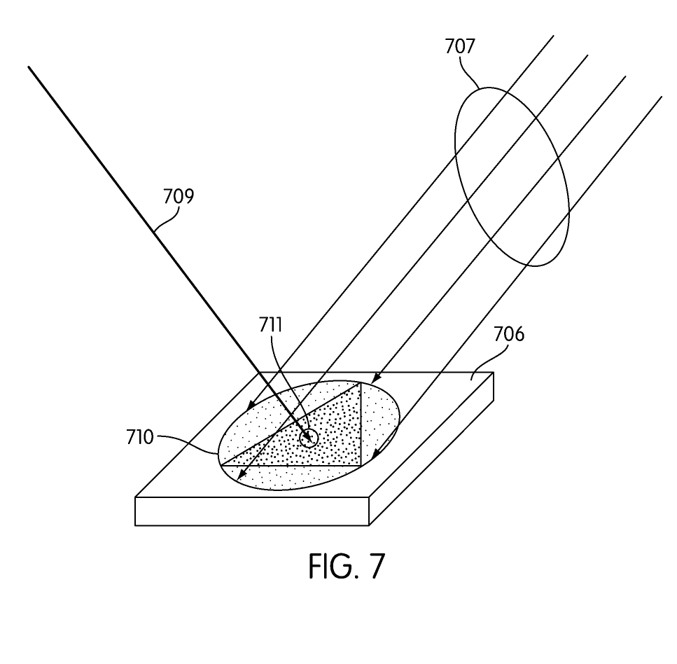

FIG. 7 illustrates how the optical mapping and screening of a sample of combinatorial materials phase diagram 710 may be accomplished using the photoreflectance measurement technique: with the incident quasi-monochromatic light 707 uniformly illuminating the entire sample 710, the modulated laser beam 709 is focused onto a spot region of interest 711 of the sample to generate a differential reflectance signal from that very spot. The ratio of the cross-sectional area of modulated laser beam 709 to the cross-sectional area of the incident quasi-monochromatic light 707 may be about 1 to 10, 1 to 100, 1 to 1,000, and 1 to 10,000 in various embodiments of the invention.

Although the photodetector 611 receives substantially all of the reflected light 612 from the sample, only the signal from the spot 711 that is being laser modulated is differentiated and amplified by a phase-sensitive lock-in detection system. Steering mirror 610 may be used to steer the modulating laser beam across the entire sample so that the spectral response from various spots can be quickly and accurately measured. Optical transition energies associated with the fundamental band gap of various locations on the combinatorial material phase diagram 710 may be mapped out and subsequently correlated to the synthesis conditions for further refinement.

What is claimed is:

1. A system for producing a combinatorial library of materials, the system comprising:
a vacuum chamber;
a substrate contained within the vacuum chamber;
a source target of precursor materials;
an ion beam for sputtering precursor material from the source target such that the precursor materials are deposited on the substrate;
a masking shutter system for controlling the amounts of each of the precursor materials that are deposited on the substrate; and
a laser beam for thermally activating the precursor materials that have been deposited on the substrate, and for causing the formation of a product from the precursor materials.

2. The system of claim 1, wherein the compositional gradient of the product varies in a continuous manner.

3. The system of claim 1, wherein the compositional gradient of the product varies in a discrete manner.

4. The system of claim 1, wherein the product is a phase diagram.

5. The system of claim 1, further including:
a quasi-monochromatic light source for illuminating an area of a surface of the product;
a modulated laser beam focused onto a region smaller than and within the area illuminated by the quasi-monochromatic light, and configured to generate a differential reflectance signal;
a photodetector for receiving reflected light from the product; and
a phase-sensitive lock-in detection system for differentiating and amplifying the differential reflectance signal detected by the photodetector.

6. The system of claim 5, wherein the ratio of the area of the modulated laser beam to the quasi-monochromatic light source ranges from 1:1 to 1:10.

7. The system of claim 5, wherein the ratio of the area of the modulated laser beam to the quasi-monochromatic light source ranges from 1:10 to 1:100.

8. The system of claim 5, wherein the ratio of the area of the modulated laser beam to the quasi-monochromatic light source ranges from 1:100 to 1:1,000.

9. The system of claim 5, wherein the ratio of the area of the modulated laser beam to the quasi-monochromatic light source ranges from 1:1,000 to 1:10,000.

10. The system of claim 5, further including a steering mirror for moving the modulated laser beam to different regions of the product receiving the quasi-monochromatic light.

11. A method of producing a combinatorial library of materials, the method comprising:
sputtering precursor materials from source target such that the precursor materials are deposited on a substrate; and
thermally activating the precursor materials on the substrate to cause reaction between the precursor materials and form a product.

12. The method of claim 10, further including:
illuminating a surface of the product with quasi-monochromatic light;
focusing a modulated laser beam onto a region within, and smaller than, the region of the product illuminated by the quasi-monochromatic light; and
detecting a differential reflectance signal from the region of the product receiving the modulated laser light.
